(19) United States
(12) Patent Application Publication
(10) Pub. No.: US 2015/0150226 A1
(43) Pub. Date: Jun. 4, 2015

(54) Scent Releasing Fishing Lure

(71) Applicant: Phillip Brian McLeod, Chesapeake, VA (US)

(72) Inventor: Phillip Brian McLeod, Chesapeake, VA (US)

(21) Appl. No.: 14/321,183

(22) Filed: Jul. 1, 2014

Related U.S. Application Data
(60) Provisional application No. 61/911,527, filed on Dec. 4, 2013.

(51) Int. Cl. A01K 85/01

(52) U.S. Cl. CPC A01K 85/01

(57) ABSTRACT

A scent releasing fishing lure for use in releasing a fish attractant while being reeled through a water stream includes a lure body having a continuous outer wall having a front end and a rear end opposed to the front end and defining an interior area. The front end defines an inlet and the rear end defines an outlet configured to receive and release a water stream, respectively. A water channel is situated in the interior area and connects the inlet and outlet, the water channel being configured to transfer water from the inlet to the outlet. A scent compartment is positioned in the interior area of the lure body and configured to selectively retain the fish attractant, the scent compartment defining an opening in fluid communication with the water channel such that the fish attractant is released into the water stream.

### CROSS REFERENCE TO RELATED APPLICATION

This patent application claims the priority of U.S. Provisional Patent Application No. 61/911,527 filed on Dec. 4, 2013 titled “FISHING LURE” which is incorporated by reference in its entirety herein.

### BACKGROUND OF THE INVENTION

The present invention relates to fishing lures and, more particularly, to a fishing lure that emits a fish attracting scent as it is reeled through the water in use.

A fishing lure is a type of artificial bait often used to catch fish and is an alternative to using live bait. A fishing lure may use movement, vibration, sound, and color to attract the attention of a fish so as to induce the fish to strike the lure, i.e. to “lure” the fish. Fishing lures are often used as bait when fishing, especially if live bait is unavailable. A fishing lure is typically equipped with one or more hooks to “hook” onto a fish when it strikes.

Although current fishing lures are generally effective for their intended purposes, conventional artificial lures fail to naturally mimic natural food for fish. Specifically, the current fishing lures lack having or disseminating a scent that attracts fish, which is an important component to attracting and enticing fish. In addition, most lures on the market also are made from plastic or rubber, often causing fish to release after striking.

Therefore, it would be desirable to have a scent releasing fishing lure that releases a fish attractant as the lure is reeled through a body of water. Further, it would be desirable to have a scent releasing fishing lure that enables a user to insert a fish attractant into the body of the lure such that the attractant is gradually released as the lure is reeled in. In addition, it would be desirable to have a scent releasing fishing lure that receives water through an inlet such the water passes over the fish attractant and is released through an outlet.

### SUMMARY OF THE INVENTION

A scent releasing fishing lure for use in releasing a fish attractant while being reeled through a body of water according to the present invention includes a lure body having a continuous outer wall having a front end and a rear end opposed to the front end and defining an interior area. The front end defines an inlet and the rear end defines an outlet configured to receive and release a water stream, respectively. A water channel is situated in the interior area and connects the inlet and outlet, the water channel being configured to transfer water from the inlet to the outlet. A scent compartment is positioned in the interior area of the lure body and configured to selectively retain the fish attractant, the scent compartment defining an opening in fluid communication with the water channel such that the fish attractant is released into the water stream.

Therefore, a general object of this invention is to provide a scent releasing fishing lure for releasing a fish attracting scent into a body of water as the lure is reeled in toward a fishing pole.

Another object of this invention is to provide a scent releasing fishing lure, as aforesaid, that includes a lure body having an inlet for receiving water, an outlet for releasing water, and a water channel connecting the inlet and outlet.

Still another object of this invention is to provide a scent releasing fishing lure, as aforesaid, having a scent compartment configured to hold a fish attractant and to deposit portions of the attractant into a water stream flowing from the inlet to the outlet.

Yet another object of this invention is to provide a scent releasing fishing lure, as aforesaid, having a sound chamber with sound elements that provide an audible sound or vibration when the fishing lure is pulled through a body of water.

A further object of this invention is to provide a scent releasing fishing lure, as aforesaid, that is easy to use and cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a scent releasing fishing lure according to a preferred embodiment of the present invention;

FIG. 2 is a side view of the fishing lure as in FIG. 1;

FIG. 3 is a top view of the fishing lure as in FIG. 1; and

FIG. 4 is a sectional view taken along line 4-4 of FIG. 3.

### DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, the scope of the invention being best defined by the appended claims.

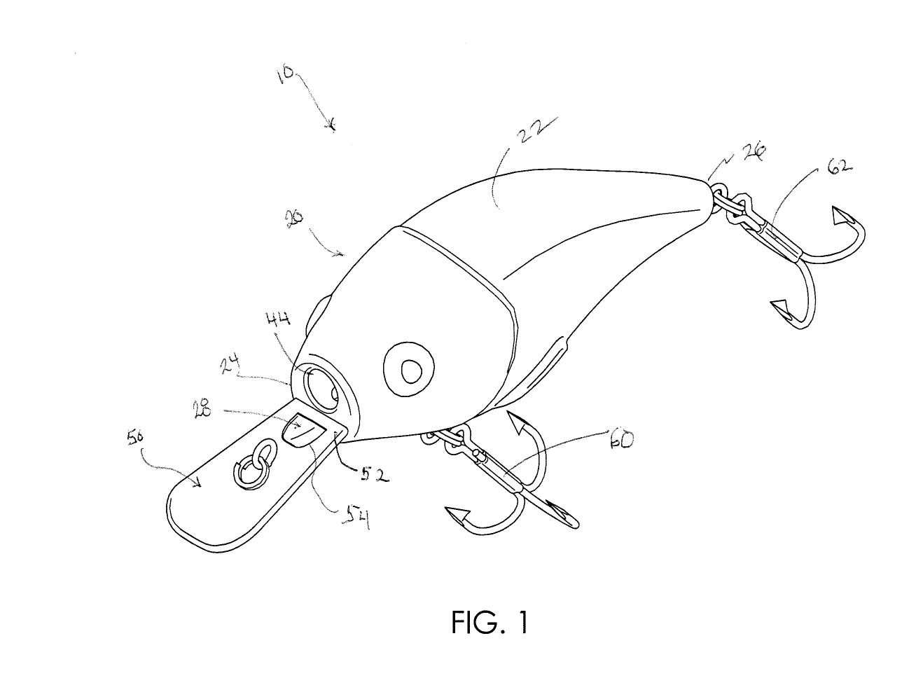

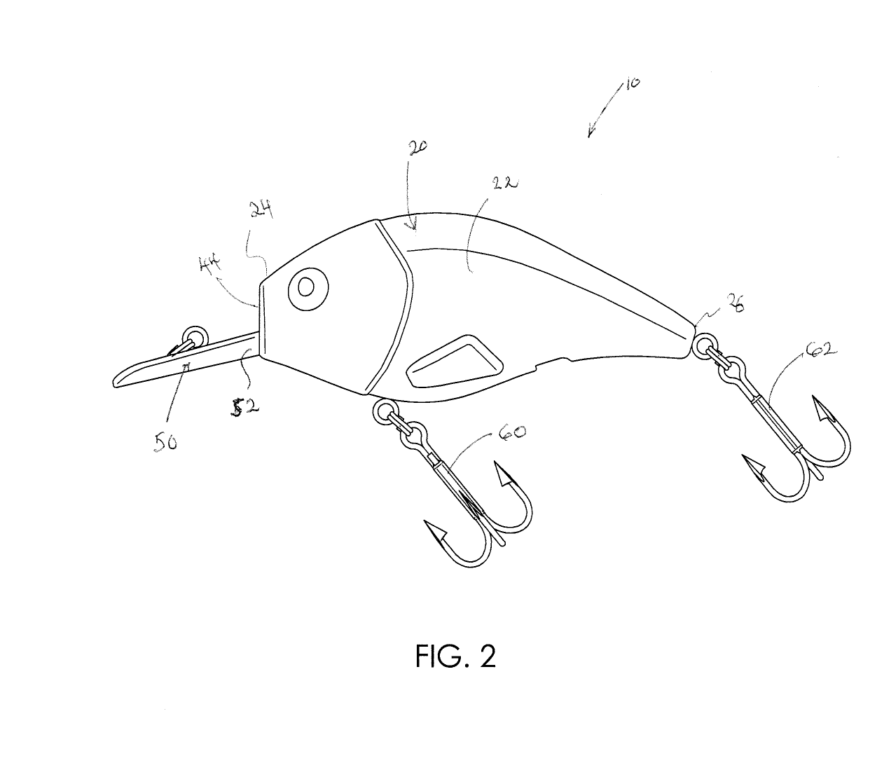

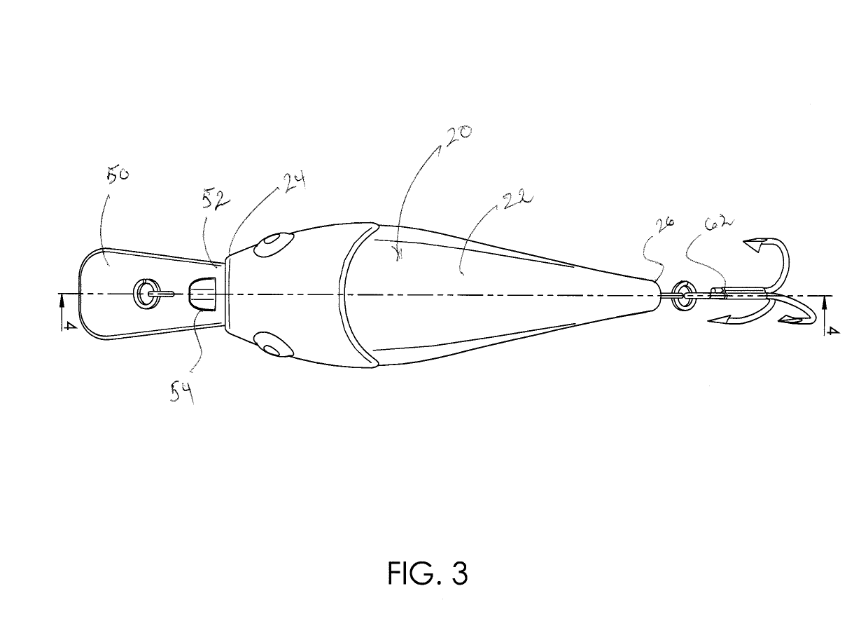

A scent releasing fishing lure 10 according to a preferred embodiment of the present invention will now be described with reference to FIGS. 1 to 4 of the accompanying drawings.

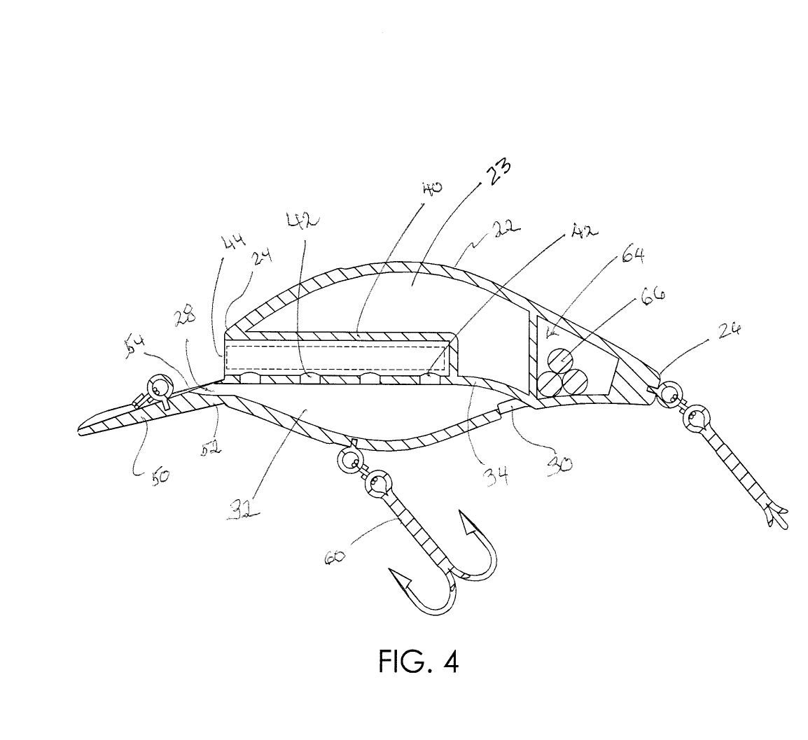

The scent releasing fishing lure 10 includes a lure body 20 having a generally continuous outer wall 22 having a front end 24 and a rear end 26 opposed from the front end 24. The outer wall 22 defines an interior area. The lure body 20 may be in the shape of a fish as is common with fishing lures. The front end 24 of the outer wall 22 of the lure body 20 may define an inlet 28 that is configured to receive a water stream in use. The outer wall 22 of the lure body 20 defines an outlet 30 displaced from the inlet 28. The outlet 30 may be somewhat adjacent the rear end 26 of the outer wall 22 although the outlet 30 is preferably positioned along a bottom portion thereof as shown in FIG. 4.

A water channel 32 is positioned in the interior area of the lure body 20 and extends between the inlet 28 and the outlet 30. The water channel 32 may be defined by a portion of the outer wall 22 and by an interior wall 34 so as to form a generally tubular channel through which a fluid stream may pass. For instance, when the fishing lure 10 is connected to a fishing line and is being reeled through the water in the normal course of fishing, a stream of water is received through the inlet 28 into the water channel 32 and then released back into the water stream through the outlet 30 (FIG. 4).

A scent compartment 40 is situated in the interior area of the lure body 20 at a position between the inlet 28 and outlet 30 (FIG. 4). The scent compartment 40 may include closed side walls and an end wall or may be tubular and is configured to contain a fish attractant 8 therein. It is understood that the fish attractant may be in the form of a gel or paste that slowly dissolves in an aqueous environment such as a lake or stream. The scent compartment 40 defines at least one opening 44, i.e. a front opening, in fluid communication with the water channel 32 such that portions of fish attractant is received into the water channel 32 and then released through the outlet 30. Preferably, a wall of the scent compartment 40 defines a plurality of openings 44 through which the fish attractant may be communicated into the water channel 32.

The outer wall 22 of the lure body 20 defines a front opening 44 in fluid communication with the interior space of the scent compartment 40 (FIG. 1). The front opening 44 is adjacent the inlet 28. The front opening 44 is configured to receive a stream of water, such as when the fishing lure 10 is being pulled through the water. As water flows into the scent compartment 40, portions of the fish attractant are urged through the one or more openings 44 so as to communicate the fish attractant into the water channel 32 and then out through the outlet 30.

The lure body 20 defines an upper cavity 23 that is airtight and essentially provides an air pocket giving buoyancy to the lure body 20 (FIG. 4). Preferably, the upper cavity 23 may be positioned atop the scent compartment 40 although other configurations may also be suitable.

In one embodiment, the fishing lure 10 includes a guide member 50 having a first end 52 coupled to the front end 24 of the outer wall 22 of the lure body 20. The guide member 50 may have a generally planar configuration that extends away from the lure body 20 although other configurations may also be suitable. The first end 52 of the guide member 50 may include an aperture 54 in communication with the inlet 28, the guide member 50 being configured to direct a stream of water through the inlet 28 into the water channel 32. Similarly, the first end 52 of the guide member 50 is adjacent the front opening 44 of the lure body 20 such that water is directed into the front opening 44 and into the scent compartment 40 as described above.

The fishing lure 10 may include a hook member 60 coupled to an outer surface of the outer wall 22 of the lure body 20 (FIG. 1). The hook member 60 may include two or more hooks and may be loosely coupled to the outer wall 22 so as to be movable as the fishing lure 10 is pulled through water in use. Another hook member 62 may be loosely coupled to the rear end 26 of the lure body 20.

In another aspect of the invention, a sound chamber 66 may be situated in the interior area defined by the outer wall 22 of the lure body 20 (FIG. 4). In one embodiment, the sound chamber 66 may be situated adjacent to the rear end 26 of the outer wall 22 although other positions in the lure body 20 would also work. A plurality of sound elements 68 is positioned within an interior space defined by the sound chamber 66. The sound elements 68 may be plastic or metal spheres that vibrate or make a vibration or an audible sound when the lure body is moved whether in or out of water. It is understood that the sound chamber 66 has a construction that is airtight so as not to become filled with water. In one embodiment (not shown), the floor/bottom of the sound chamber 66 may have a generally V-shaped configuration defining a center channel in which the sound elements 68 come to rest when the lure body is at rest so as to enhance the stability of the lure.

In some embodiments, the fishing lure 10 can be molded out of any hard supportive material including, but not limited to, plastic and various types of metal, then mechanically press glued, molded together, or the like. In certain embodiments, the inlet 28 may potentially be utilized in various positions in the front of the lure body 20 and serve the same purpose. The inlet 28 may, in some embodiments, include multiple inlets. In certain embodiments, the scent compartment 40 may be of various sizes and shapes with holes of various sizes depending on the application.

In use, a scent attractant may be inserted into the scent compartment 40 through the front opening 44. Once the lure enters the water and has began to be reeled in, the water pressure at the front opening 44 of the scent compartment 40 caused by the reeling, may cause the attractant to be forced out of the scent compartment 40 through the plurality of openings 44 into the internal water channel 32 through which a water stream having entered through the inlet 28 is flowing. The passing water stream may then carry the attractant/water mixture out of the outlet 30 of the lure body 20. In this manner, the fish attractant is released into the surrounding body of water through which the fishing lure 10 is being reeled.

It is understood that while certain forms of this invention have been illustrated and described, it is not limited thereto except insofar as such limitations are included in the following claims and allowable functional equivalents thereof.

1. A scent releasing fishing lure for use in releasing a fish attractant into a water stream, comprising:
a lure body having a generally continuous outer wall having a front end and a rear end opposed to said front end and defining an interior area;
wherein:
said front end defines an inlet configured to receive the water stream;
said rear end defines an outlet displaced from said inlet configured to release the water stream;
said outer wall defines a water channel situated in said interior area and extending between said inlet and said outlet, said water channel being configured to allow the water stream to pass from said inlet to said outlet;
a scent compartment positioned in said interior area of said lure body and configured to selectively retain the fish attractant, said scent compartment defining an opening in fluid communication with said water channel such that the fish attractant is released into said water stream.

2. The fishing lure as in claim 1, wherein said scent compartment is situated between said inlet and said outlet.

3. The fishing lure as in claim 1, wherein said front end of said outer wall of said lure body defines a front opening in fluid communication with said scent compartment, said front opening configured to receive the water stream.

4. The fishing lure as in claim 3, wherein said front opening is adjacent said inlet.

5. The fishing lure as in claim 1, comprising:
a sound chamber situated in said interior area of said lure body, said sound chamber defining a sealed interior space; and
a plurality of sound elements loosely situated in said interior space of said sound chamber and configured to make one of a vibration or an audible sound upon movement of said lure body.

6. The fishing lure as in claim 5, wherein said sound chamber is positioned adjacent said rear end of said outer wall of said lure body.

7. The fishing lure as in claim 3, comprising:
a sound chamber situated in said interior area of said lure body, said sound chamber defining a sealed interior space; and
a plurality of sound elements loosely situated in said interior space of said sound chamber and configured to make one of a vibration or an audible sound upon movement of said lure body.

8. The fishing lure as in claim 1, comprising a hook member coupled to an outer surface of said outer wall of said lure body.

9. The fishing lure as in claim 1, comprising a hook member coupled to said rear end of said outer wall of said lure body.

10. The fishing lure as in claim 1, comprising a guide member having a first end coupled to said front end of said outer wall of said lure body and extending away therefrom.

11. The fishing lure as in claim 10, wherein said first end of said guide member defines an aperture in fluid communication with said inlet and configured to guide the water stream into said inlet.

12. The fishing lure as in claim 4, comprising a guide member having a first end coupled to said front end of said outer wall of said lure body and extending away therefrom, said first end positioned adjacent said front opening of said lure body and configured to guide the water stream into said front opening.

13. A scent releasing fishing lure for use in releasing a fish attractant into a stream of water, comprising:
a lure body having a generally continuous outer wall having a front end and a rear end opposed to said front end and defining an interior area;
wherein:
said front end defines an inlet configured to receive the water stream;
said outer wall defines an outlet displaced from said inlet configured to release the water stream;
a water channel situated in said interior area and extending between said inlet and said outlet, said water channel being configured to allow the water stream to pass from said inlet to said outlet;
a scent compartment positioned in said interior area of said lure body and configured to selectively retain the fish attractant, said scent compartment defining an opening in fluid communication with said water channel such that the fish attractant is released into the water stream;
wherein said front end of said outer wall of said lure body defines a front opening in fluid communication with said scent compartment, said front opening configured to receive the water stream.

14. The fishing lure as in claim 13, wherein said scent compartment is situated between said inlet and said outlet.

15. The fishing lure as in claim 13, wherein said front opening is adjacent said inlet.

16. The fishing lure as in claim 13, comprising:
a sound chamber situated in said interior area of said lure body, said sound chamber defining a sealed interior space; and
a plurality of sound elements loosely situated in said interior space of said sound chamber and configured to make one of a vibration or an audible sound upon movement of said lure body.

17. The fishing lure as in claim 16, wherein said sound chamber is positioned adjacent said rear end of said outer wall of said lure body.

18. The fishing lure as in claim 13, comprising a guide member having a first end coupled to said front end of said outer wall of said lure body and extending away therefrom.

19. The fishing lure as in claim 18, wherein said first end of said guide member defines an aperture in fluid communication with said inlet and configured to guide the water stream into said inlet.

20. The fishing lure as in claim 18, wherein said first end of said guide member is positioned adjacent said front opening of said lure body and configured to guide the water stream into said front opening.

21. The fishing lure as in claim 13, wherein said outer wall of said lure body defines an upper cavity that is airtight and configured to give buoyancy to the lure body.
